(19) United States
(12) Patent Application Publication
(10) Pub. No.: US 2014/0305583 A1
(43) Pub. Date: Oct. 16, 2014

(54) Device and method for applying a micostructured coating to a substrate using a prepolymerized resin tape

(71) Applicant: Airbus Operations (SAS), Toulouse (FR)

(72) Inventor: Laurent Casset, Colomiers (FR)

(21) Appl. No.: 14/249,517

(22) Filed: Apr. 10, 2014

(30) Foreign Application Priority Data
Apr. 12, 2013 (FR) 20130053353

(51) Int. Cl. B32B 37/06

(52) U.S. Cl. CPC B32B 37/06
USPC 156/275.5; 156/380.9

(57) ABSTRACT

A method and a device for applying a microstructured coating to the surface of a substrate, using a prepolymerized curable resin tape in the pasty state of which at least the face that is to be applied to the substrate is initially covered with a protective film, which protective film is peeled off during the course of the method so as to apply the resin tape directly to the substrate. The use of a prepolymerized resin tape makes it possible to avoid the risks of runs and variations in quality which are associated with the use of a liquid material and makes it possible to avoid the problems associated with the ageing of a microstructured matrix in the form of a reusable tape.

### CROSS-REFERENCES TO RELATED APPLICATIONS

This application claims the benefit of the French patent application No. 20130053353 filed on Apr. 12, 2013, the entire disclosures of which are incorporated herein by way of reference.

### BACKGROUND OF THE INVENTION

The present invention relates to the formation of microstructures on substrates, particularly although not exclusively on aircraft wing or fuselage elements, so as to obtain a microstructured coating of the type commonly referred to as a “riblet” or a “sharkskin” coating.

US Patent Application 2007/0257400 A1 describes, in FIG. 3 thereof, a device comprising an endless elastic tape forming a microstructured matrix and mounted on a set of three rollers arranged overall in a triangle and themselves mounted so that they can rotate on a chassis (not depicted). The device further comprises a source of UV radiation.

That device works as follows: the outer face of the tape is coated with a photocurable resin then the device is pressed against the surface of a substrate that is to be covered with a microstructured coating. More specifically, the abovementioned two rollers are pressed against this surface so as to bring the outer face of the applicator strand of the tape into contact with the substrate, and the device is moved over this substrate to cause the tape to roll thereover. During this movement of the device, the source of UV radiation causes the resin applied to the substrate to cure. The cured resin then detaches from the tape to adhere to the substrate as the corresponding part of the tape runs around the roller situated to the rear relative to the direction of translational movement of the device. As the device is gradually moved over the substrate, a layer of cured resin exhibiting the desired microstructures is thus obtained on this substrate.

The alternative forms described in FIGS. 1 and 2 of the abovementioned document respectively comprise just one and two rollers, whereas those described in FIGS. 4 and 5 comprise an open strip.

All of these devices do however have the disadvantage that the pressure with which the curable resin is pressed against the substrate is not controlled with sufficient precision and is not sufficiently uniform.

This problem is particularly acute when using these devices to apply a coating to a downwardly facing surface, i.e., when the pressure with which the device is applied to the substrate is oriented upwards, because of the elasticity of the tape and because the weight of its resin-covered bottom strand then acts in opposition against the application pressure.

Moreover, coating the tape with a fluid resin carries risks of flash and runs, thus complicating the use of the method and making it longer and costlier while at the same time increasing the risks of variations in the quality of the microstructured coating obtained.

In addition, the elastic tape that forms the microstructured matrix becomes worn over time, and this likewise makes controlling the quality of the microstructured coating obtained more difficult.

### SUMMARY OF THE INVENTION

It is a notable object of the invention to provide a simple, economical and effective solution to these problems.

To this end, the invention proposes an applicator device for applying a microstructured coating to a surface of a substrate, comprising:
a chassis,
a main reel mounted so that it can rotate on the said chassis to pay out a prepolymerized curable resin tape,
an applicator roller mounted so that it can rotate on the said chassis to press a lower face of the prepolymerized curable resin tape onto the substrate,
a first auxiliary reel coupled to the said applicator roller, to recover a protective film that protects the lower face of the prepolymerized curable resin tape,
microstructuring means for forming microstructures in the prepolymerized curable resin tape, and
a curing device positioned behind the said applicator roller relative to a direction of forward travel of the said applicator device and intended to perform final polymerization of the prepolymerized curable resin tape.

The advantages inherent to the applicator device according to the invention lie in the possibility of employing the method of application according to the invention described hereinbelow and will therefore become more clearly apparent in the explanations which follow.

In one preferred embodiment of the invention, the said applicator roller has microstructures forming the said microstructuring means.

Moreover, the applicator device advantageously comprises a second auxiliary reel coupled to the said applicator roller to recover a protective film that protects the upper face of the prepolymerized curable resin tape.

The invention also relates to a method of applying a microstructured coating to a surface of a substrate using an applicator device of the type described hereinabove.

According to the invention, the method comprises the following steps:
loading a prepolymerized curable resin tape into the applicator device so that the said resin tape is wound around the said main reel, at least one face of the said resin tape, referred to as the “lower face”, being covered by a peelable protective film, referred to as “lower film”;
passing a free end of the resin tape between the said applicator roller and the said first auxiliary reel;
peeling one end of the said lower film from the said free end of the resin tape then fixing the said end of the said lower film to the said first auxiliary reel so as to begin winding the said lower film onto the said first auxiliary reel;
placing the said free end of the resin tape onto the said surface of the substrate, facing the said curing device, the said lower face of the resin tape being on the substrate side;
activating the said curing device;
moving the said applicator device in its direction of forward travel while pressing the said applicator roller onto a face, referred to as the “upper face”, of the resin tape, the opposite face to the said lower face, so that:
i. the said main reel progressively pays out the resin tape,
ii. the said lower film progressively detaches from the resin tape and is wound around the said first auxiliary reel,
iii. the said microstructuring means form microstructures in the upper face of the resin tape, and so that
iv. the said curing device causes the curing of the microstructured resin tape as the latter moves past this curing device, and
obtaining a microstructured coating formed of the cured resin tape adhering to the surface of the substrate.

In general, the method according to the invention allows the creation of a microstructured coating on a substrate in a way that is simple and effective and avoids the risk of runs and variations in quality that are connected with the use of a liquid material, at the same time avoiding problems associated with the ageing of a microstructured matrix. The prepolymerized resin tape may be produced on an industrial scale in a way that allows rigorous control over width, thickness, chemical composition of the resin tape, something which is not the case when the resin is poured in liquid form onto a matrix or onto the surface that is to be coated, as is the case with the methods of the prior art.

The method according to the invention also offers good control over the pressure with which the resin tape is pressed onto the substrate.

This method also has the advantage of being usable for applying a coating to a downwardly facing surface, and to a surface that has a double curvature.

Of course, the resin tape is of calibrated thickness.

For preference, the said upper face of the resin tape is covered with a peelable protective film, referred to as “upper film”.

In a first preferred embodiment of the invention, the said applicator roller has microstructures forming the said microstructuring means.

In this case, the said applicator device preferably comprises a second auxiliary reel, the said method comprising, prior to activation of the curing device, a step that consists in peeling an end of the said upper film from the said free end of the resin tape, then fixing the said end of the said upper film to the said second auxiliary reel so as to begin winding the said upper film onto the said second auxiliary reel, and so that the resin tape does not have the said upper film when it reaches the said applicator roller.

In a second preferred embodiment of the invention, the said upper film has microstructures forming the said microstructuring means.

In this case, the said applicator device preferably comprises a second auxiliary reel, the said method comprising, prior to activation of the curing device, a step that consists in peeling an end of the said upper film from the said free end of the resin tape, then fixing the said end of the said upper film to the said second auxiliary reel so as to begin winding the said upper film onto the said second auxiliary reel.

As an alternative, the curing of the resin tape may be performed through the said upper film.

In this case, the applicator device may have no second auxiliary reel.

### BRIEF DESCRIPTION OF THE DRAWINGS

The invention will be better understood and further details, advantages and features thereof will become apparent from reading the following description given by way of nonlimiting example and with reference to the attached drawings in which:

FIG. 1 is a schematic view in cross section of an applicator device during the implementation of a method of applying a microstructured coating to a substrate according to a first embodiment of the invention;

FIG. 1a is an exploded schematic partial view in longitudinal section of a prepolymerized resin tape used in combination with the applicator device of FIG. 1;

FIG. 2 is a schematic view in cross section of an applicator device during the implementation of a method of applying a microstructured coating to a substrate according to a second embodiment of the invention;

FIG. 2a is an exploded schematic partial view in longitudinal section of a prepolymerized resin tape used in combination with the applicator device of FIG. 2;

FIG. 2b is a larger-scale view of detail IIb of FIG. 2;

FIG. 3 is a schematic view in cross section of an applicator device during the implementation of a method of applying a microstructured coating to a substrate according to an alternative form of the second embodiment of the invention.

Throughout these figures, identical references may denote elements that are identical or similar.

### DETAILED DESCRIPTION OF THE PREFERRED EMBODIMENTS

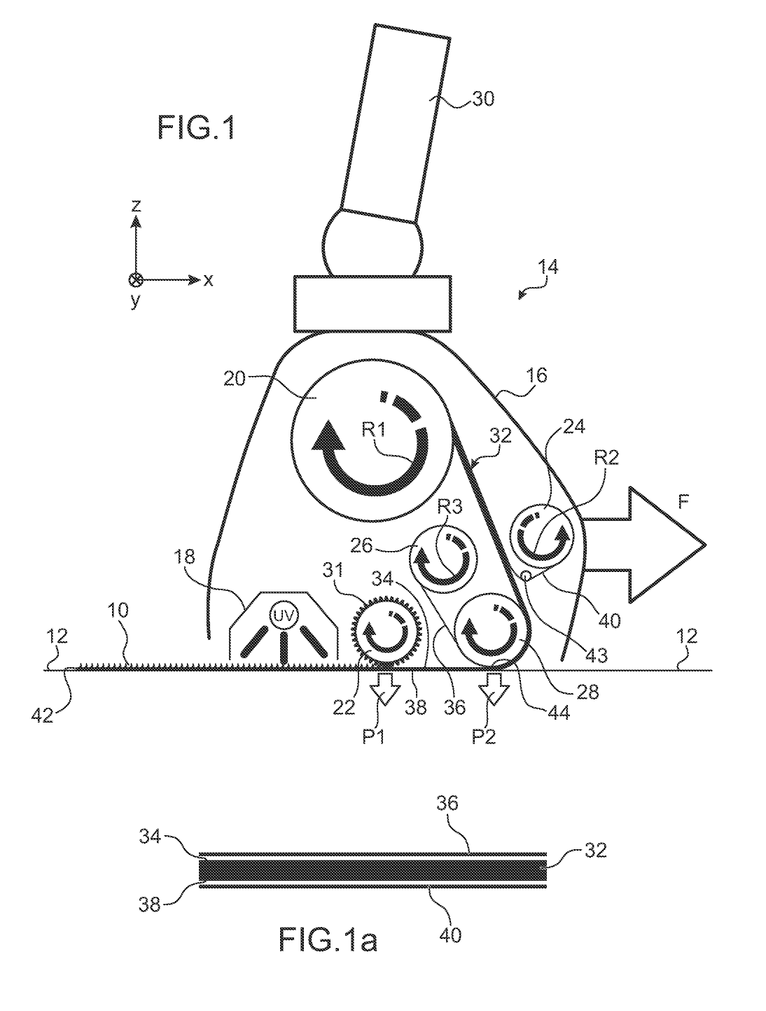

FIG. 1 illustrates the key step in a method of applying a microstructured coating 10 to a surface 12 of a substrate, according to a first embodiment of the invention.

This method is implemented using an applicator device 14 comprising a chassis 16 and a curing device which is, for example, formed of a source 18 of ultraviolet radiation. The applicator device 14 further comprises a main reel 20, an applicator roller 22, a first auxiliary reel 24, a second auxiliary reel 26 and a guide roller 28, which are all mounted so that they can rotate on the chassis 16. The means connecting these elements to the chassis 16 are not visible in FIG. 1 and may be of conventional type.

Each aforementioned reel comprises a cylinder of revolution together with, for preference, two lateral retaining flanges, in the well known way.

The first auxiliary reel 24 is coupled to the main reel 20 so that a rotation R1 of the main reel 20 causes a rotation R2 of the first auxiliary reel 24 in the opposite direction. The second auxiliary reel 26 is coupled to the main reel 20 so that a rotation R1 of the main reel 20 causes a rotation R3 of the second auxiliary reel 26 in the direction of rotation of the main reel 20. The various coupling means provided for this purpose are not visible in FIG. 1 and may be of conventional type. The coupling means are configured to produce a transmission ratio chosen according to the respective diameters of the reels 20, 24, 26.

The chassis 16 has a concave overall shape so as to delimit an open volume on a lower side of the applicator device 14. This chassis 16 is preferably provided with a coupling member 30 intended to connect the applicator device 14 to a robot arm.

In the embodiment illustrated in FIG. 1, the applicator roller 22 has microstructures 31 projecting radially outwards. This applicator roller is, for example, produced by micromachining or by molding.

Throughout this description, the direction referred to as the longitudinal direction X of the applicator device 14 is a direction parallel to a direction of forward travel F of this device, and a vertical direction of the applicator device 14 is referred to as Z and a transverse direction orthogonal to the previous two is referred to as Y.

Prior to the step illustrated in FIG. 1, the method involves beforehand loading a prepolymerized curable resin tape 32 into the applicator device 14. This loading essentially consists in winding the resin tape 32 around the main reel 20 or placing a resin tape 32 available in the form of a roll around the cylinder of the main reel 20.

In the example illustrated, the resin tape 32 is made of a photocurable resin, i.e., a resin that can be cured under the action of the UV radiation produced by the source 18. The resin is prepolymerized, which means to say that the resin tape 32 has already undergone the beginnings of a polymerization giving it geometric stability, i.e., conferring upon it a pasty state. The dynamic viscosity of the prepolymerized resin is thus preferably higher than 102 Pa·s.

A detailed example of a source of UV radiation and of a suitable photocurable resin can be found at paragraph 109 of the aforementioned document US 2007/0257400 A1.

In addition, the resin tape 32 has a calibrated thickness, which means to say that this resin tape 32 has been designed to have a predetermined thickness that is substantially constant along the resin tape.

The resin tape 32 has an upper face 34 covered with a peelable protective film 36, referred to as “upper film”, and a lower face 38 covered with a peelable protective film 40, referred to as “lower film” (FIG. 1a).

The protective films 36 and 40 may for example be made of silicone-treated paper or silicone-treated polyethylene or even of silicone-treated polyester, while at the same time remaining transparent to the UV radiation supposed to initiate the polymerization of the resin, so as to limit the adhesion of the films to the resin tape and thus make them easier to peel, and guarantee the geometry of the riblets and satisfactory protection of the resin tape.

The method continues with a free end 42 of the resin tape 32 being passed between the applicator roller 22 and the first auxiliary reel 24 and, more specifically, between the guide roller 28 and the first auxiliary reel 24 (FIG. 1).

One end of the lower film 40 is then peeled from the free end 42 of the resin tape 32 then fixed to the first auxiliary reel 24 so that subsequent rotation thereof causes the lower film 40 to wind onto this first auxiliary reel 24.

In the example illustrated, the applicator device 14 comprises a guide rod 43 intended to move the guide roller 28 closer to the peeling zone of the lower film 40. For that, the guide rod 43 is in fact positioned between the guide roller 28 and the first auxiliary reel 24, and the resin tape 32 extends between the guide rod 43 and the guide roller 28. In addition, the lower film 40 runs around the guide rod 43, resting against it.

The resin tape 32 is then pulled around the guide roller 28 then one end of the upper film 36 is peeled from the free end 42 of the resin tape 32 then fixed to the second auxiliary reel 26 so that subsequent rotation thereof causes the upper film 36 to wind onto this second auxiliary reel 26.

The resin tape 32 is then pulled to a point below the source 18 of UV radiation, passing under the applicator roller 22, then this resin tape 32 is placed onto the surface 12 of the substrate, the lower face 38 of the resin tape 32 being on the same side as the said surface 12.

The applicator device 14 is kept facing the surface 12 of the substrate so that the applicator roller 22 applies a pressure P1 to the resin tape 32 in the direction of the surface 12 of the substrate. For preference, the guide roller 28 also applies a pressure P2 pressing the resin tape 32 against the substrate.

The source 18 of UV radiation is then activated so as to cure the free end of the resin tape 32 and thus cause it to adhere to the surface 12 of the substrate.

As an alternative, that region of the surface 12 on which the free end 42 of the resin tape 32 is applied may be covered beforehand with a peelable protective coating, to which the resin tape is applied, so as to allow subsequent removal of the free end 42 of the resin tape. The relevant region of the surface 12 is then preferably chosen to be in a hidden area, i.e., an area that does not need to be covered with the microstructured coating.

The method continues with the key step illustrated in FIG. 1 and which consists in moving the applicator device 14 over the surface 12 of the substrate so as to apply thereto a microstructured coating formed of the cured resin tape 12.

To this end, as the applicator device 14 is moved in its direction of forward travel F, the main reel 20 progressively pays out the resin tape 32 in reaction to the resistance applied by the adhesion to the substrate of the polymerized resin tape after passing under the UV boom and in reaction to the tension applied to the resin tape as a result of the movement of the applicator device 14.

The paying-out of the resin tape 32 is accompanied by the progressive peeling of the upper 36 and lower 40 films and by the winding of these onto the auxiliary reels 26 and 24 respectively, because of each of the auxiliary reels 24, 26 being coupled in rotation to the main reel 20.

The lower film 40 is separated from the resin tape 32 before the latter reaches the guide roller 28 so that at the point of contact 44 between the resin tape and the surface of the substrate, the resin tape is free of the lower film 40 and is therefore applied directly to the substrate.

The upper film 36 is separated from the resin tape 32 after the guide roller 28 relative to the direction of paying-out of the resin tape 32 but before the latter reaches the applicator roller 22, so that the applicator roller 22 is applied directly to the resin tape 32.

In addition, the applicator roller 22 moves over the resin tape 32 imparting to it microstructures of a complementary shape to the microstructures formed on the applicator roller 22.

The movement of the applicator device 14 causes the source 18 of UV radiation to move along the resin tape 32 and thus brings about the curing of each portion of resin tape 32 already applied to the surface 12 of the substrate and in which the microstructures have already been formed by the applicator roller 22.

The dimension of the microstructures of the coating 10 thus obtained has been exaggerated in the figures for the sake of clarity. These microstructures preferably have dimensions (depth and spacing between two adjacent microstructures) of between 5 μm and 120 μm.

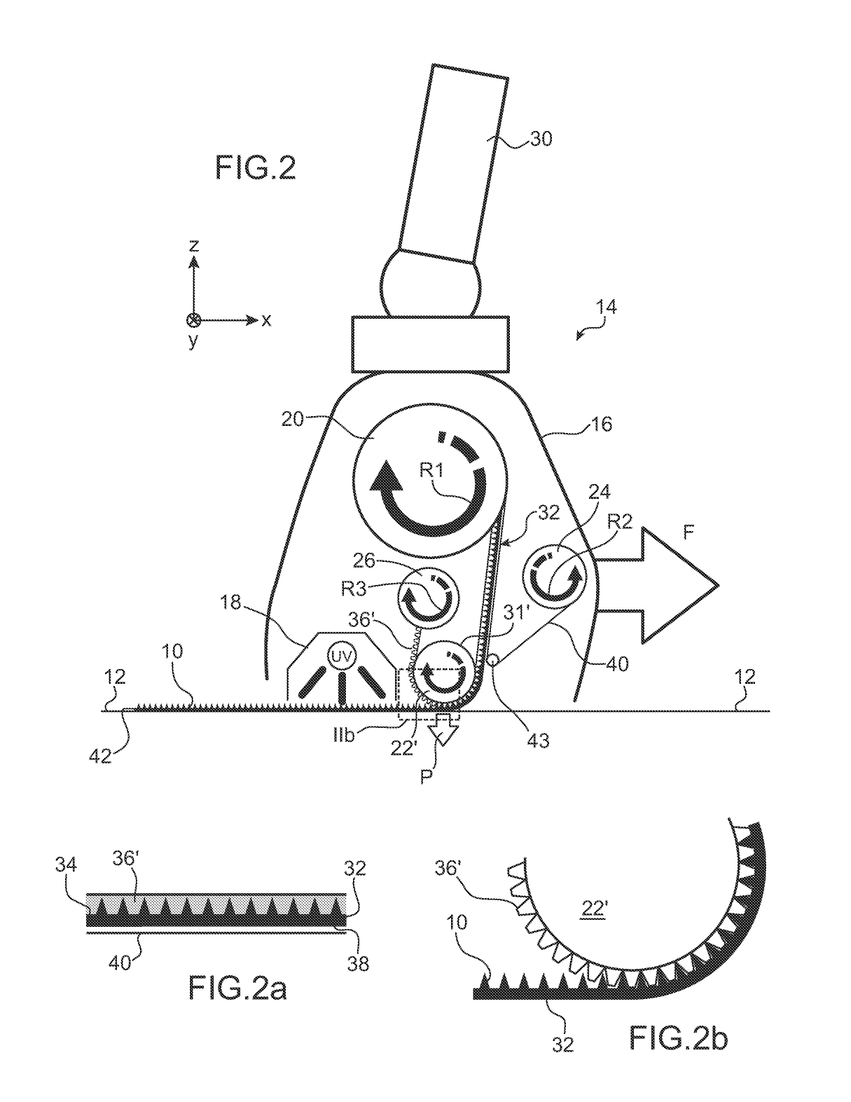

In the second embodiment of the invention which is illustrated in FIG. 2, the upper film 36′ of the resin tape 32 has microstructures which, with shapes that are the complement thereof, define the microstructures of the upper face 34 of the resin tape 32 (FIG. 2a).

The applicator roller 22′ by contrast has no microstructures and thus has a smooth exterior surface 31′ (FIG. 2).

The presence of a specific guide roller is superfluous here so the applicator device 14 has no such guide roller. All of the pressure P for pressing the resin tape 32 onto the surface 12 of the substrate is therefore applied by the applicator roller 22′.

In the example illustrated in FIG. 2, the applicator device 14 comprises a second auxiliary reel 26 similar to that of FIG. 1. However, to afford better protection to the resin tape 32 and its microstructures, the upper film 36′ is peeled before the source 18 of UV radiation but after the applicator roller 22′, relative to the direction in which the resin tape 32 is paid out. Thus, the upper film 32′ runs around the applicator roller 22′ before reaching the second auxiliary reel 26 (FIGS. 2 and 2b).

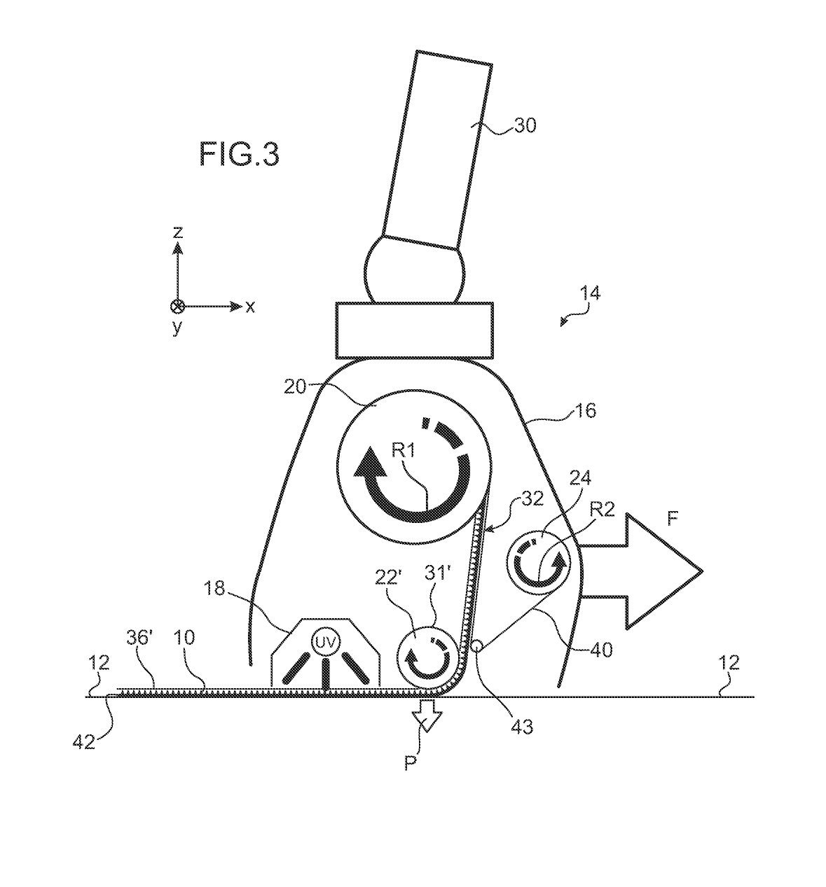

As an alternative, as FIG. 3 illustrates, the photocuring of the resin tape 32 may be performed through the upper film 36′. In such a case, the latter is designed to be insensitive to the UV radiation and to be at least partially transparent to this radiation.

In that case it is possible for the applicator device 14 not to have the second auxiliary reel 26, as in the example of FIG. 3.

In general, the method and the applicator device 14 according to the invention allow a microstructured coating to be formed on a substrate in a simple and effective way avoiding the risks of runs and variations in quality which are associated with the use of a liquid material and avoiding the problems associated with the ageing of a microstructured matrix in the form of a reusable tape. The prepolymerized resin tape can be produced on an industrial scale in a way that allows rigorous control over the width, thickness and chemical composition of the resin tape.

This method described hereinabove also has the advantage of being usable for applying a coating to a downwardly facing surface, and to a surface having a double curvature.

The method also allows good control over the pressure with which the resin tape is pressed onto the substrate, using the applicator roller 22, 22′ and, where appropriate, the guide roller 28.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An applicator device for applying a microstructured coating to a surface of a substrate, comprising:
a chassis,
a main reel mounted so that it can rotate on the chassis to pay out a prepolymerized curable resin tape,
an applicator roller mounted so that it can rotate on the chassis to press a lower face of the prepolymerized curable resin tape onto the substrate,
a first auxiliary reel coupled to the applicator roller, to recover a protective film that protects the lower face of the prepolymerized curable resin tape, microstructuring means for forming microstructures in the prepolymerized curable resin tape, and
a curing device positioned behind the applicator roller relative to a direction of forward travel of the applicator device and intended to perform final polymerization of the prepolymerized curable resin tape.

2. The applicator device according to claim 1, in which the applicator roller has microstructures forming the microstructuring means.

3. The applicator device according to claim 1, further comprising a second auxiliary reel coupled to the applicator roller to recover a protective film that protects an upper face of the prepolymerized curable resin tape.

4. The method of applying a microstructured coating to a surface of a substrate using an applicator device according to claim 1, comprising the following steps:
loading a prepolymerized curable resin tape into the applicator device so that the resin tape is wound around the main reel, at least one face of the resin tape, referred to as the “lower face”, being covered by a peelable protective film, referred to as “lower film”;
passing a free end of the resin tape between the applicator roller and the first auxiliary reel;
peeling one end of the lower film from the free end of the resin tape then fixing the end of the lower film to the first auxiliary reel so as to begin winding the lower film onto the first auxiliary reel;
placing the free end of the resin tape onto the surface of the substrate, facing the curing device, the lower face of the resin tape being on the substrate side;
activating the curing device;
moving the applicator device in its direction of forward travel while pressing the applicator roller onto a face, referred to as the “upper face”, of the resin tape, the opposite face to the lower face, so that:
i. the main reel progressively pays out the resin tape,
ii. the lower film progressively detaches from the resin tape and is wound around the first auxiliary reel,
iii. the microstructuring means form microstructures in the upper face of the resin tape, and so that
iv. the curing device causes the curing of the microstructured resin tape as the latter moves past this curing device, and
obtaining a microstructured coating formed of the cured resin tape adhering to the surface of the substrate.

5. The method according to claim 4, wherein the upper face of the resin tape is covered with a peelable protective film, referred to as “upper film”.

6. The method according to claim 4, wherein the applicator roller has microstructures forming the microstructuring means.

7. The method according to claim 5, wherein the applicator roller has microstructures forming the microstructuring means and wherein the applicator device comprises a second auxiliary reel, the method further comprising,
prior to activation of the curing device, a step that includes peeling an end of the upper film from the free end of the resin tape, then fixing the end of the upper film to the second auxiliary reel so as to begin winding the upper film onto the second auxiliary reel, and so that the resin tape does not have the upper film when it reaches the applicator roller.

8. The method according to claim 5, wherein the upper film has microstructures forming the microstructuring means.

9. The method according to claim 8, wherein the applicator device comprises a second auxiliary reel, the method comprising, prior to activation of the curing device, a step that includes peeling an end of the upper film from the free end of the resin tape, then fixing the end of the upper film to the second auxiliary reel so as to begin winding the upper film onto the second auxiliary reel.

10. The method according to claim 8, wherein the curing of the resin tape is performed through the upper film.
